(19) United States
(12) Patent Application Publication
(10) Pub. No.: US 2007/0054520 A1
(43) Pub. Date: Mar. 8, 2007

(54) Receptacle with overload protection

(76) Inventor: Zu Yao Wu, Dou-Liu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/208,751

(22) Filed: Aug. 23, 2005

(51) Int. Cl. H01R 13/648

(52) U.S. Cl. 439/106

(57) ABSTRACT

A receptacle with overload protection includes a bimetallic member mounted on two fixing seats electrically connected to two elastic contact plates of the receptacle. The bimetallic member includes two contacts that normally contact with each other to form a close circuit in the receptacle. When an electric appliance plugged into the two elastic contact plates is overloaded to cause a temperature rise in the receptacle, the two contacts of the bimetallic member automatically separate from each other to form an open circuit in the receptacle, so that power supplied to the electric appliance via the receptacle is interrupted to protect the electric appliance and the receptacle from damage due to overload. The two contacts of the bimetallic member automatically contact with each other again when the temperature at the receptacle is lowered to a safety range.

### FIELD OF THE INVENTION

The present invention relates to a receptacle with overload protection, and more particularly to a receptacle overload protection adapted to automatically form an open circuit in the receptacle to cut off power supplied to an electric appliance via the receptacle when the electric appliance is overloaded, and automatically form a close circuit again when the overload condition disappears.

### BACKGROUND OF THE INVENTION

FIG. 1 shows a conventional receptacle via which public power is supplied to an electric appliance plugged thereto. The conventional receptacle includes a main body 1 internally provided with one or more pairs of spaced elastic contact plates 11 and a conductive plate 12 electrically connected to the elastic contact plates 11. After a power cord is connected to the conductive plate 12, a cover plate 2 is closed onto a top of the main body 1. When an electric appliance is plugged into the elastic contact plates 11, power is supplied to the electric appliance. It is noted there is not any overload protection provided on the above-structured conventional receptacle.

An overload protection is usually provided at a main power supply end. However, when a certain electric appliance plugged to a receptacle connected to a part of the indoor wiring is in a current overload condition, a temperature rise would occur at that part of indoor wiring and the receptacle to even result in damage of the electric appliance or some worse condition, such as fire.

### SUMMARY OF THE INVENTION

A primary object of the present invention is to provide a receptacle with overload protection, so that an open circuit is formed at the receptacle when an electric appliance plugged therein is overloaded.

To achieve the above and other objects, the receptacle with overload protection according to the present invention includes a bimetallic member mounted on two fixing seats electrically connected to two elastic contact plates of the receptacle. The bimetallic member includes two contacts that normally contact with each other to form a close circuit in the receptacle. When an electric appliance plugged into the two elastic contact plates is overloaded to cause a temperature rise in the receptacle, the two contacts of the bimetallic member automatically separate from each other to form an open circuit in the receptacle, so that power supplied to the electric appliance via the receptacle is interrupted to protect the electric appliance and the receptacle from damage due to overload. The two contacts of the bimetallic member automatically contact with each other again when the temperature at the receptacle is lowered to a safety range.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional receptacle;

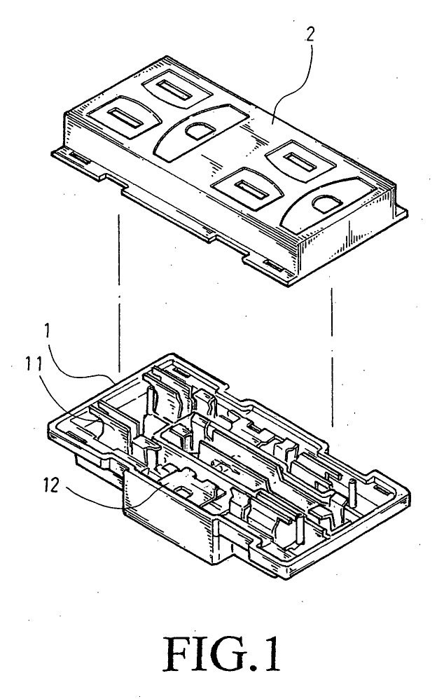

FIG. 2 is an exploded perspective view of a receptacle with overload protection according to a preferred embodiment of the present invention;

FIG. 3 is a partially assembled perspective view of the receptacle of FIG. 2;

FIG. 4 is a side view showing the operation of a bimetallic member included in the present invention; and

FIG. 5 shows another embodiment of the bimetallic member of the present invention.

### DETAILED DESCRIPTION OF THE PREFERRED EMBODIMENTS

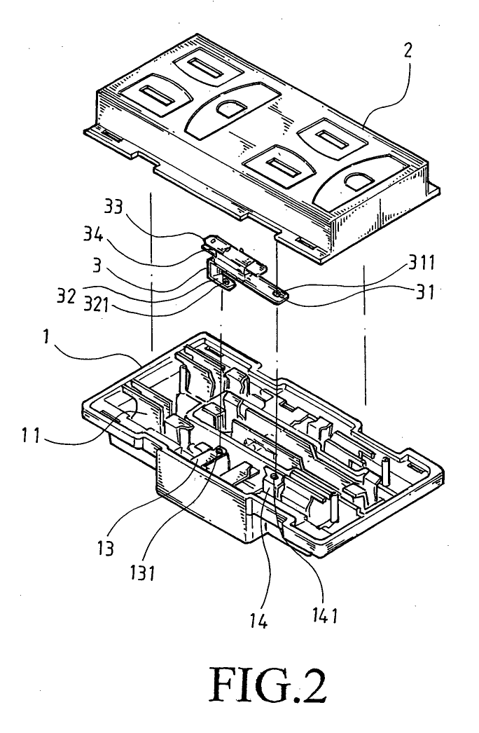

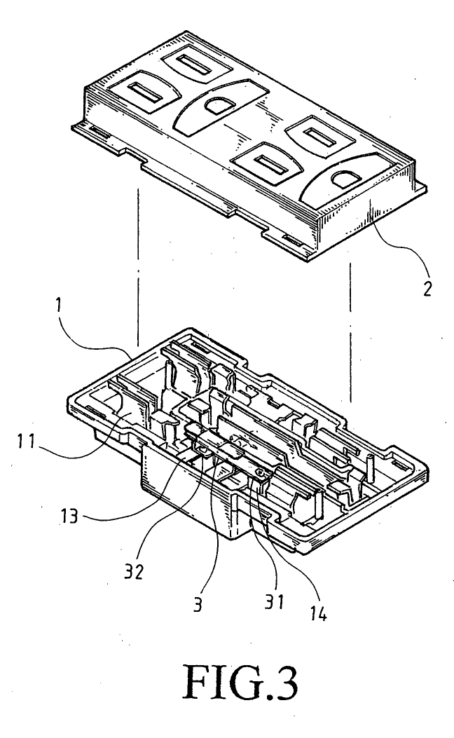

Please refer to FIGS. 2 and 3 that are exploded and partially assembled perspective views, respectively, of a receptacle with overload protection according to a preferred embodiment of the present invention. As shown, the receptacle of the present invention includes a main body 1, a cover plate 2 closing a top of the main body 1, and a bimetallic member 3.

The main body 1 is internally provided with at least one pair of spaced elastic contact plates 11, and two fixing seats 13, 14 electrically connected to the two elastic contact plates 11. The two fixing seats 13, 14 are provided on a top with a screw hole 131, 141 each.

The bimetallic member 3 includes a first end in the form of a straight plate 31, on a free end of which there is provided a fixing hole 311; and a second end in the form of a downward extended L-shaped plate having a horizontal bent section 32 extended toward and in parallel with the straight plate 31. The bent section 32 is also provided at a free end with a fixing hole 321. The bimetallic member 3 is fixedly connected at the first and the second end to the tops of the two fixing seats 14, 13 by extending fastening elements (not shown) through the aligned fixing holes 311, 141 and 321, 131, so as to firmly locate in the main body 1.

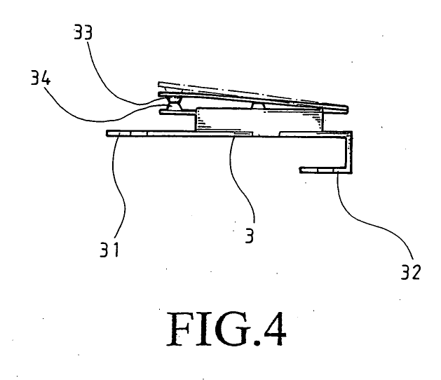

Please refer to FIG. 4. The bimetallic member 3 is provided at one of two ends with two contacts 33, 34 that are normally in contact with each other to form a close circuit in the receptacle. When the receptacle is connected to a power source, power is supplied to the two elastic contact plates 11 via the two mutually touched contacts 33, 34 of the bimetallic member 3. When an electric appliance (not shown) is plugged into the two elastic contact plates 11 on the receptacle, power is supplied to the electric appliance via the elastic contact plates 11.

In the event the electric appliance plugged in the receptacle is in an abnormal condition to cause an overload, a temperature rise at the receptacle will occur. When the bimetallic member 3 detects the temperature rise and deforms, the contacts 33, 34 on the bimetallic member 3 become separated from each other to form an open circuit in the receptacle, and power supplied to the elastic contact plates 11 is interrupted. That is, no power is further supplied to the receptacle and the electric appliance plugged therein, protecting them from damage due to overload and preventing any other disaster possibly caused by constant rising of temperature at the receptacle.

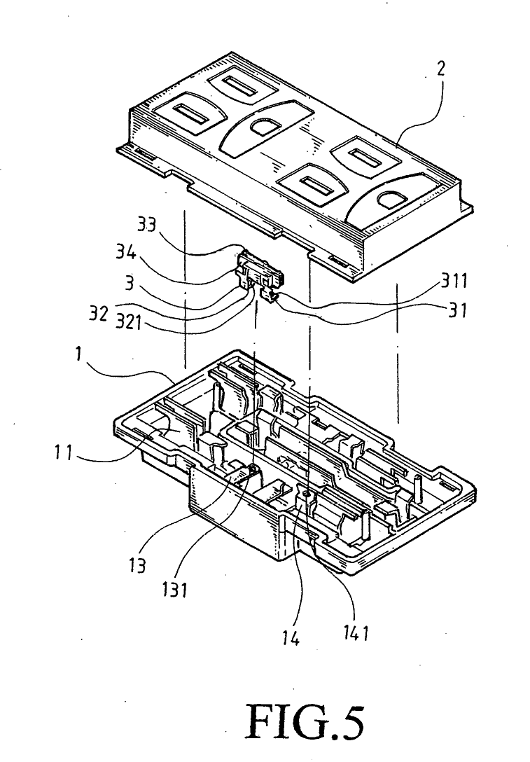

FIG. 5 shows another embodiment of the bimetallic member 3. In this embodiment, the bimetallic member 3 includes two plates 31, 32 vertically downward extended from two ends thereof. As in the first embodiment, the metallic member 3 of the second embodiment is connected to the tops of the fixing seats 13, 14 by means of extending fastening elements through the aligned fixing holes 311, 141 and 321, 131, so as to firmly locate in the main body 1.

When the temperature at the receptacle is lowered to a safety range, the two contacts of the bimetallic member 3 automatically contact with each other again to form a close circuit in the receptacle, allowing supply of power to the elastic contact plates 11 and the electric appliance.

What is claimed is:

1. A receptacle with overload protection, comprising a main body being internally provided with at least one pair of spaced elastic contact plates, and two fixing seats electrically connected to said two elastic contact plates; and a bimetallic member being connected at two ends to said two fixing seats in said main body and having two contacts provided thereon; said two contacts on said bimetallic member being normally contacting with each other to form a close circuit in said receptacle and allow power to be supplied from a power source to said two elastic contact plates via said bimetallic member, and said two contacts on said bimetallic member being separated from each other to form an open circuit in said receptacle to cut off power supplied to said elastic contact plates when an electric appliance plugged into said elastic contact plates is overloaded to cause temperature rise in said receptacle, protecting said electric appliance and said receptacle from damage due to overload.
